(19) United States
(12) Patent Application Publication
(10) Pub. No.: US 2012/0308776 A1
(43) Pub. Date: Dec. 6, 2012

(54) CERMET COATING, SPRAYING PARTICLES FOR FORMING SAME, METHOD FOR FORMING CERMET COATING, AND COATED ARTICLE

(76) Inventors: Seiji Kuroda, Ibaraki (JP); Makoto Watanabe, Ibaraki (JP); Masayuki Komatsu, Ibaraki (JP); Kazuto Sato, Aichi (JP); Junya Kitamura, Aichi (JP)

(21) Appl. No.: 13/512,080

(22) PCT Filed: Nov. 26, 2010
(86) PCT No.: PCT/JP2010/071185

§ 371 Date: Aug. 20, 2012

(30) Foreign Application Priority Data
Nov. 27, 2009 (JP) 2009-270280

(51) Int. Cl. B32B 15/02; B05D 1/12; B22F 1/00

(52) U.S. Cl. 428/148; 75/252; 427/201; 75/230

(57) ABSTRACT

The present invention provides a cermet coating that can take advantage of the hardness of a powder for a hard reinforcement phase more effectively, and spraying particles for forming the cermet coating. The cermet coating is formed on a base surface and has a hard reinforcement phase and a binder phase. The cermet coating has a Vickers hardness of from 50% to less than 100% of the hardness of the powder for a hard reinforcement phase, and has a surface roughness (center-line average roughness Ra) of less than 3.0. The cermet coating is formed by heating spraying particles prepared as aggregates of a powder for a hard reinforcement phase and a powder for a binder phase, and applying the spraying particles to a base at a supersonic velocity to integrate the powder for a hard reinforcement phase with the powder for a binder phase.

### TECHNICAL FIELD

The present invention relates to a cermet coating that has a hard reinforcement phase and a binder phase, and is formed from spraying particles including a powder for a hard reinforcement phase and a powder for a binder phase. The invention also relates to spraying particles for forming the cermet coating, a cermet coating forming method, and a coated article.

### BACKGROUND ART

As described in Patent Document 1, a method of forming a cermet coating on a base surface is known in which spraying particles having a hard reinforcement phase and a binder phase are heated and applied to a base at a supersonic velocity.

It has been shown in the known art that such a cermet coating has a high Vickers hardness.

However, the Vickers hardness is very poor considering the hardness of the hard reinforcement phase of the spraying particles, and does not sufficiently take advantage of the particle characteristics.

### CITATION LIST

### Patent Document

Patent Document 1 JP-A-2008-69377

### SUMMARY OF INVENTION

### Problems that the Invention is to Solve

Under these circumstances, it is an object of the present invention to provide a cermet coating that can take advantage of the hardness of the powder for a hard reinforcement phase more effectively. The invention also provides spraying particles for forming the cermet coating, a cermet coating forming method, and a coated article.

### Means for Solving the Problems

A cermet coating of the present invention is a cermet coating having a hard reinforcement phase and a binder phase formed on a base surface by the collision of spraying particles with a base, the spraying particles including a ceramic powder as a powder for a hard reinforcement phase for forming the hard reinforcement phase of the cermet coating, and a metal powder as a powder for a binder phase for forming the binder phase of the cermet coating,

wherein the cermet coating has a Vickers hardness of from 50% to less than 100% of the Vickers hardness of the powder for a hard reinforcement phase.

It is preferable that the cermet coating has a surface roughness (center-line average roughness Ra) of less than 3.0.

In the cermet coating, the spraying particles are aggregates of the powder for a hard reinforcement phase and the powder for a binder phase, and the cermet coating is formed by the integration of the powder for a hard reinforcement phase and the powder for a binder phase after the spraying particles are heated and applied onto the base at a supersonic velocity.

In the cermet coating, it is preferable that the powder for a hard reinforcement phase be one or more carbide ceramics selected from WC, Cr₃C₂, VC, NbC, TaC, TiC, ZrC, HfC, SiC, and B₄C, or one or more non-carbide ceramics selected from diamond, TiN, AlN, HfB₂, ZrB₂, TaB₂, and TiB₂.

In the cermet coating, it is preferable that the powder for a binder phase be one or more metals selected from Ni, Cr, Co, Ti, Al, and Fe, or an alloy thereof.

A spraying particle of the present invention is a spraying particle that includes a powder for a hard reinforcement phase and a powder for a binder phase for forming any of the cermet coatings above,

wherein the powder for a binder phase accounts for not more than 25 mass % and not less than 8 mass % of the total of the spraying particle.

In the spraying particle, it is preferable that the powder for a hard reinforcement phase and the powder for a binder phase form an aggregate.

A coated article of the present invention has a base that includes any of the foregoing cermet coatings formed on a base surface.

A cermet coating forming method of the present invention is a method for forming any of the foregoing cermet coatings, and includes: heating spraying particles that include a ceramic powder for a hard reinforcement phase for forming the hard reinforcement phase of the cermet coating, and a metal powder for a binder phase for forming the binder phase of the cermet coating; and causing the spraying particles to collide with the base at a supersonic velocity to deposit the cermet coating having a hard reinforcement phase and a binder phase.

In the cermet coating forming method, it is preferable that the spraying particles collide with the base after being heated to not less than the softening temperature and less than the melting temperature of the metallic component forming the powder for a binder phase.

In the cermet coating forming method, it is preferable that the spraying particles be aggregates of the powder for a hard reinforcement phase and the powder for a binder phase.

### Advantage of the Invention

The cermet coating of the present invention can take advantage of the inherent hardness of the powder for a hard reinforcement phase, and thus has a hardness about twice as large as that described in Patent Document 1, and has a very flat surface. Specifically, the cermet coating can have a surface roughness (center-line average roughness Ra) of less than 3.0. This was made possible by reducing the particle diameter of the spraying particles from that described in Patent Document 1, and by thus increasing the Vickers hardness of the cermet coating. This result was obtained rather surprisingly out of concerns about the influence of the property change caused by the melting of the heated spraying particles.

The cermet coating, and an article coated therewith thus have a wide range of practical applications, and improved reliability.

### BRIEF DESCRIPTION OF DRAWINGS

FIG. 1 is a schematic cross sectional view representing a cross section of a spray gun used in the present invention.

FIG. 2 is a photographic representation of a spraying particle.

FIG. 3 is a photographic representation of a cermet coating.

FIG. 4 is a photographic representation showing a cross section of a cermet coating produced by using the warm spray technique in Example 2.

FIG. 5 is a diagram representing the surface roughness of the cermet coating produced in Example 2 plotted against the average particle diameter of each spraying particle.

FIG. 6 is a diagram representing the relationship between the surface roughness Ra and cross section hardness (Hv) of a cermet coating produced in Example 3.

FIG. 7 is a diagram representing the measured surface roughness of a cermet coating produced in Example 4, in which (a) represents the measured data along X direction, and (b) represents the measured data along Y direction orthogonal to X direction.

FIG. 8 is a diagram representing the surface roughness Ra (center-line average roughness) plotted for the cermet coating produced in Example 4.

### BEST MODE FOR CARRYING OUT THE INVENTION

While the characteristics of the present invention have been described above, the following describes an embodiment of the present invention.

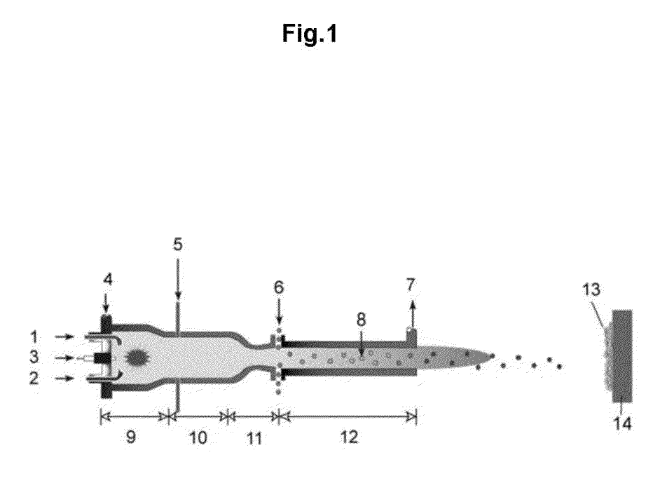

FIG. 1 is a cross sectional view schematically illustrating an example of a warm spray gun used to form a cermet coating by the warm spray technique. The warm spray gun includes a combustion chamber (9) and a supersonic nozzle (11), the former being provided with a fuel inlet (1), an oxygen gas inlet (2), and a spark plug (3). A mixing chamber (10) including an inert gas inlet (5) for nitrogen gas or the like is provided between the combustion chamber (9) and the supersonic nozzle (11). In the mixing chamber (10), the room-temperature inert gas supplied through the inert gas inlet (5) is mixed with the combustion flame generated in the combustion chamber (9), allowing for the control of the temperature and the speed of the gas flow reaching the supersonic nozzle (11).

The nozzle (11) at the apex portion has a feedstock supply port (6) for spraying particles (8), and a barrel (12) is attached to the tip of the feedstock supply port (6). The combustion chamber (9), the mixing chamber (10), the nozzle (11), and the barrel (12) are cooled by coolants (4) and (7).

The spraying particles (8) are configured from a ceramic powder and a metal powder. The ceramic powder is a powder for a hard reinforcement phase for forming the hard reinforcement phase of a cermet coating (13), whereas the metal powder is a powder for a binder phase for forming the binder phase of the cermet coating (13). The spraying particles (8) fed through the feedstock supply port (6) are heated to a specific temperature and accelerated to a specific speed range by the high-velocity gas flow generated as the temperature-controlled combustion flame in the mixing chamber (10) expands and accelerates through the supersonic nozzle (11). The spraying particles (8) so heated and accelerated collide with a base (14) and deposit thereon to form the cermet coating (13) having a hard reinforcement phase and a binder phase.

Cermet coating formation involves problems, including formation of a brittle alloy phase resulting from the melting of the hard reinforcement phase into the metallic phase (binder phase), and composition changes in the hard reinforcement phase due to decarburization reaction. A key to solving these problems is to maintain the spraying particles at a temperature no greater than the melting point of the metal powder for a binder phase. The melting point of the metallic component forming the powder for a binder phase ranges from 1,455 to 1,857° C.

By using the warm spray technique, the amounts of inert gas such as nitrogen supplied into the mixing chamber (10) can be controlled to heat the spraying particles (8) to a temperature at or above the softening temperature and less than the melting point of the metallic component forming the powder for a binder phase, and to accelerate the spraying particles (8) to Mach 1 or higher. In the present invention, the spraying particles (8) are heated to a temperature at or above the softening temperature and less than the melting point of the metallic component forming the powder for a binder phase, and accelerated at a supersonic velocity equal to or greater than Mach 1. In this way, the melt reaction and the decomposition reaction of the spraying particles (8) can be greatly suppressed during the flight of the spraying particles (8). As a result, the cermet coating (13) can be densely produced on the base (14) while suppressing the melting of the hard reinforcement phase into the binder phase, or the decomposition due to decarburization.

Further, in the present invention, in order to improve the quality of the cermet coating, one or more carbides selected from carbide ceramics such as WC, Cr₃C₂, VC, NbC, TaC, TiC, ZrC, HfC, SiC, and B₄C, or one or more compounds selected from non-carbide ceramics such as diamond, TiN, AlN, HfB₂, ZrB₂, TaB₂, and TiB₂ are considered as a typical composition of the powder for a hard reinforcement phase forming the spraying particles. As for the powder for a binder phase forming the spraying particles, one or more metals selected from Ni, Cr, Co, Ti, Al, and Fe, or an alloy of these are considered.

Further, in the present invention, a base preheat temperature range of 100 to 500° C. is considered as a condition for forming a cermet coating of improved quality and for fabricating a coated member.

Preferably, the base preheat temperature is maintained at 500° C. or less, in order to prevent the melting, structural changes, and oxidation of the base materials. Further, the base preheat temperature is desirably 100° C. or more, in order to activate the base surface during the coating adhesion process.

It is desirable that the powder for a hard reinforcement phase have a particle diameter of 0.1 to 2.0 μm, preferably 0.1 to 0.3 μm.

When the particle diameter of the powder is too large, sufficient flatness may not be obtained because the large size of the hard reinforcement phase becomes a more contributing factor for the surface roughness of the cermet coating. Further, the low surface area-to-volume ratio may lower the surface energy to make adhesion difficult and facilitate rebound.

When the particle diameter of the powder for a hard reinforcement phase is too small, handling becomes very difficult, and the cost increases.

On the other hand, the powder for a binder phase has a particle diameter of preferably 2 μm or less.

The “particle diameter” is evaluated by using the Fisher technique (FSSS, Fisher Sub Sieve Sizer), or by electron microscopy. The Fisher technique is the technique for evaluating a particle diameter from the specific surface area of a powder by measuring the flow rate of a passing gas and a pressure drop in a test tube or the like charged with a predetermined amount of powder.

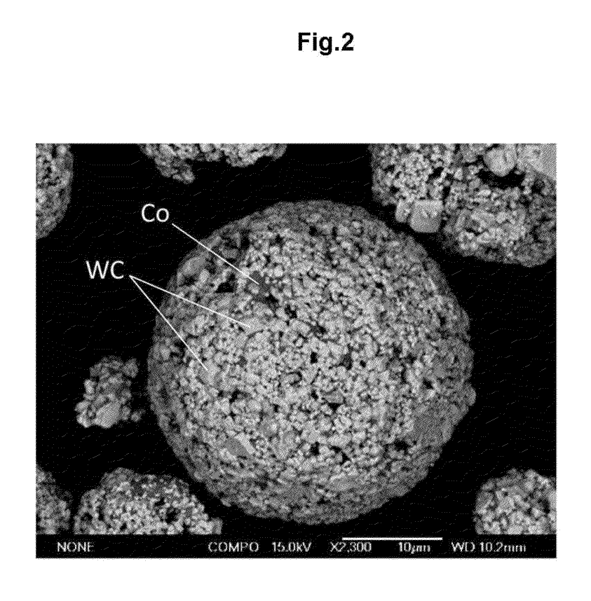

Preferably, the spraying particles are aggregates of the powder for a hard reinforcement phase and the powder for a binder phase, as shown in FIG. 2. In the figure, the white angular particles are the particles for a hard reinforcement phase, and the portions shown in dark gray are the particles for a binder phase. These powders aggregate to form a single spraying particle. For example, the particles are obtained as spherical granules by the gas atomization of a slurry produced by mixing and dispersing the powder for a hard reinforcement phase and the powder for a binder phase in a liquid. The particles can then be obtained in a predetermined particle diameter distribution after preliminary sintering, pulverization, and sieving.

The spraying particles may be used, as long as the particle size does not differ greatly from the spraying particles used in a conventionally known high-velocity flame spray technique. An even finer powder can be used by the warm spray technique. For example, it is desirable that the average particle diameter is 5 to 45 μm, preferably 5 to 30 μm, more preferably 5 to 20 μm.

The “average particle diameter” is evaluated by the laser diffraction and scattering technique. The laser diffraction and scattering technique is the technique for specifying the particle diameter from the intensity distribution of the scattered light from particles irradiated with a laser beam.

The surface roughness of the cermet coating is dependent on the size of the adhering particles. Thus, when the particle diameter of the spraying particles is excessively large, the surface roughness of the cermet coating increases. The excess particle diameter is also problematic, because it fails to provide a sufficient speed, and lowers the adhesion efficiency or porosity, or the temperature inside the particle becomes non-uniform, creating more variation in the internal structure of the coating, and thus producing a non-uniform coating.

When the particle diameter of the spraying particles is excessively small, the influence of the turbulence created by the jet flow upon colliding with the base becomes large, and sufficient adhesion efficiency cannot be obtained. Further, the excessively small particle diameter raises the particle temperature more than necessary. This is problematic because it leads to deterioration of particle properties caused by decarburization or by the melting of the hard reinforcement phase into the binder phase. Another problem is that the spraying particles adhere, which makes it difficult to supply the particles for extended time periods at a constant speed. The high-velocity flame spray technique often involves a phenomenon known as spitting, in which the molten powder particles adhere and deposit in a thermal spraying gun, and are spat in the form of coarse particles. This is highly detrimental to the coating quality. The warm spray technique hardly involves this problem, because it does not melt the particles.

In the spraying particles including a powder for a hard reinforcement phase and a powder for a binder phase, the relative amount of the powder for a binder phase may be appropriately set, for example, in a range of from 8 mass % to 25 mass % with respect to the total of the spraying particles, though the desirable proportions vary depending on the intended use. Specifically, the relative amount of the powder for a binder phase may be set to 8 mass % to 10 mass %, 11 mass % to 13 mass %, 16 mass % to 18 mass %, or 23 mass % to 25 mass % with respect to the total of the spraying particles.

The excess amount of the powder for a binder phase is problematic, because it makes the binder phase soft, and fails to provide sufficient hardness for the cermet coating.

Further, excessively small amounts of the powder for a binder phase are problematic, because the adhesion between the hard reinforcement phases will be insufficient. In this case, sufficient hardness cannot be obtained for the cermet coating, and the adhesion efficiency is poor.

As described below in Examples, the cermet coating of the present invention uses the spraying particles that include a powder for a hard reinforcement phase and a powder for a binder phase, and can thus have a Vickers hardness of at least 50%, at least 60%, at least 65%, or at least 70% of the inherent Vickers hardness of the powder for a hard reinforcement phase. By comparing the cermet coatings produced by the warm spray technique and the high-velocity flame spray technique using the powder for a hard reinforcement phase and the powder for a binder phase in the same composition with the same content of the powder for a binder phase, the cermet coating produced by the warm spray technique can have a higher hardness. So long as the spraying particles contain the powder for a binder phase in the content of from 8 mass % to 25 mass %, the Vickers hardness of the cermet coating tends to increase with decrease in the content of the powder for a binder phase.

Particularly, in the cermet coating produced by the warm spray technique using spraying particles having an average particle diameter of 5 to 20 μm, a surface roughness Ra (center-line average roughness) of 3.0 or less, 2.5 or less, 2.0 or less, or 1.5 or less may be realized.

It is preferable that the lower limit of the cermet coating thickness be 100 μm or more, preferably 150 μm or more, more preferably 200 μm or more. Desirably, the upper limit is 800 μm or less, preferably 700 μm or less, more preferably, 600 μm or less.

The invention is described below in more detail based on examples. Note, however, that that invention is not limited by the following exemplary descriptions.

### EXAMPLES

### Example 1

Cermet coatings presented in Table 1 were produced on a base surface using the warm spray technique (WS) as examples of the cermet coating of the present invention. Cermet coatings produced by using the high-velocity flame spray technique (HVOF) are also presented as Comparative Examples.

The fuel-to-oxygen ratio in Table 1 represents the relative ratio with respect to the stoichiometric ratio 1.0 for the complete combustion of the kerosene and oxygen supplied into the combustion chamber. The ratio is 1.0 or less in the presence of the excess oxygen.

The combustion pressure is the value in the combustion chamber. The coatings produced under the conditions of Table 1 used carbon steel JIS SS400 as the base, and a powder for a hard phase WC and a powder for a binder phase Co (WC-12 to 25 weight % Co) as the sprayed cermet particles (spraying particles). The particle diameters and the mutual proportions of the powder for a hard phase are as presented in Table 1. The spraying particles are aggregates of the powder for a hard reinforcement phase and the powder for a binder phase, and were obtained after the preliminary sintering, pulverization, and sieving of the granules obtained by the gas atomization of a slurry produced by mixing and dispersing the powder for a hard reinforcement phase and the powder for a binder phase in a liquid.

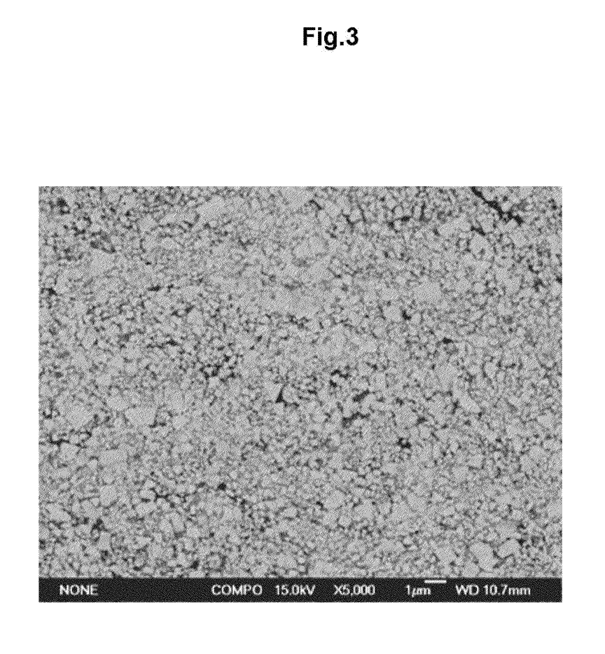

The properties of the cermet coatings produced under the conditions of Table 1 were measured. The results are presented in Table 1. FIG. 3 is a photographic representation of a cross section of the coating obtained under the condition WS3. The white gray particles present over the whole surface represent the powder for a hard layer WC. It can be seen that the particles are densely dispersed in the coating.

TABLE 1

| Experiment | Spraying particles | | | Spray conditions | | | | Cermet coating | | | |
|---|---|---|---|---|---|---|---|---|---|---|---|
| No. | WC* | Co* | D50* | 12* | 2* | 1* | L* | Thickness* | Ra* | Hy* | H % |
| HVOF1 | 2 | 12 | 31.2 | 4 | 1900 | 5.1 | 380 | 200 | 4.27 | 1073 | 51 |
| HVOF2 | 2 | 12 | 26.8 | 8 | 1900 | 5.1 | 380 | 200 | 3.43 | 1205 | 57 |
| HVOF3 | 2 | 12 | 15.5 | 8 | 1900 | 5.1 | 380 | Spitting | | | |
| HVOF4 | 2 | 12 | 31.2 | 8 | 1900 | 5.1 | 450 | 200 | 3.58 | 1251 | 60 |
| WS1 | 0.2 | 12 | 15.9 | 8 | 1100 | 4 | 200 | 237 | 2.93 | 1356 | 65 |
| WS2 | 0.2 | 12 | 15.9 | 8 | 1375 | 5 | 200 | 305 | 1.95 | 1363 | 65 |
| WS3 | 0.2 | 12 | 15.9 | 8 | 1650 | 6 | 200 | 331 | 1.44 | 1488 | 71 |
| WS4 | 0.2 | 12 | 15.9 | 8 | 1705 | 6.2 | 200 | 296 | 1.56 | 1525 | 73 |
| WS5 | 0.2 | 12 | 15.9 | 8 | 1650 | 6 | 100 | 334 | 1.85 | 1623 | 77 |
| WS6 | 0.2 | 12 | 15.9 | 8 | 1650 | 6 | 150 | 327 | 1.53 | 1633 | 78 |
| WS7 | 0.2 | 12 | 15.9 | 8 | 1650 | 6 | 300 | 307 | 2.27 | 1522 | 72 |
| WS8 | 0.2 | 12 | 15.9 | 16 | 1650 | 6 | 200 | 339 | 2.06 | 1532 | 73 |
| WS9 | 0.2 | 17 | 15.9 | 8 | 1650 | 6 | 200 | 406 | 1.44 | 1295 | 62 |
| WS10 | 0.2 | 17 | 15.9 | 16 | 1650 | 6 | 200 | 494 | 1.52 | 1282 | 61 |
| WS11 | 0.2 | 25 | 15.9 | 8 | 1650 | 6 | 200 | 280 | 1.65 | 1181 | 56 |
| WS12 | 0.2 | 25 | 15.9 | 16 | 1650 | 6 | 200 | 515 | 1.35 | 1089 | 52 |

HVOF: High-velocity flame spray technique (Spraying under no nitrogen supply to mixing chamber 10)
WS: Warm spray technique (Spraying under supplied nitrogen 1000 sim to mixing chamber 10, and involving gas temperature adjustment to 10 × 10²° C. at the barrel exit)
WC*: The size of the powder for a hard reinforcement phase (WC) contained in the spraying particles (μm)
Co*: The content of the powder for a binder phase (Co) contained in the spraying particles (mass %)
D50*: The average diameter of the spraying particles (μm)
12*: Length of barrel (12) (inch)
2*: Amount of supplied oxygen through oxygen gas inlet (2) (scfh)
1*: Amount of fuel supplied through fuel inlet (1)
L*: Distance from the tip of barrel (12) to the surface of base (14) (mm)
Thickness*: Thickness of cermet coating formed on base surface (μm)
Ra*: Surface roughness of cermet coating (center-line average roughness) (μm)
Hv*: Vickers hardness
H %: Hv* with respect to WC Vickers hardness (2100) (%)

As can be seen in Table 1, the cermet coatings produced by the warm spray technique using the spraying particles including the powder for a hard reinforcement phase and the powder for a binder phase had a Vickers hardness of at least 50%, at least 60%, at least 65%, or at least 70% of the inherent Vickers hardness of the powder for a hard reinforcement phase.

Particularly, the cermet coatings produced by the warm spray technique using spraying particles having an average particle diameter of 5 to 20 μm had a surface roughness of 3.0 or less, 2.5 or less, 2.0 or less, or 1.5 or less.

### Example 2

WC-Co coatings (cermet coatings) were produced by using the WS or HVOF technique, using carbon steel (JIS SS400, dimensions: 100×50×5^{t} mm) as the base, and particles including a powder for a hard phase WC and a powder for a binder phase Co as the sprayed cermet particles (spraying particles). The thickness was about 300 μm.

Table 2 represents the types of the spraying particles used, and the types of the deposition methods used to produce the cermet coatings. Table 3 represents the deposition conditions. The spraying particles are aggregates of the powder for a hard reinforcement phase and the powder for a binder phase, and were obtained in the same manner as in Example 1.

TABLE 2

| | | | Type of deposition |
|---|---|---|---|
| | | | method used to |
| | | | produce cermet |
| WC* | D50* | Co* | coating |
| 0.2 | 28.5 | 12 | HVOF and WS |
| | 15.9 | 12 | WS |
| | 7.5 | 12 | WS |
| 2 | 31.2 | 12 | HVOF |
| | 37.5 | 12 | HVOF |
| | 26.8 | 12 | HVOF |

WC*: The particle diameter of the powder for a hard reinforcement phase (WC) contained in the spraying particles (μm)
D50*: The average diameter of the spraying particles (μm)
Co*: The content of the powder for a binder phase (Co) contained in the spraying particles (mass %)

The surface roughness of the cermet coatings was evaluated using a contact-type roughness meter (SJ-201 R, Mitsutoyo). Measurements were made along the direction parallel to the direction of the gun movement (sample longitudinal direction). The measured distance was 12.5 mm, and the center-line average roughness Ra as a parameter was used as an index. After being cut, the sample was filled with resin, mirror polished, and observed for the cross section structure using a scanning microscope (JEOL 6500).

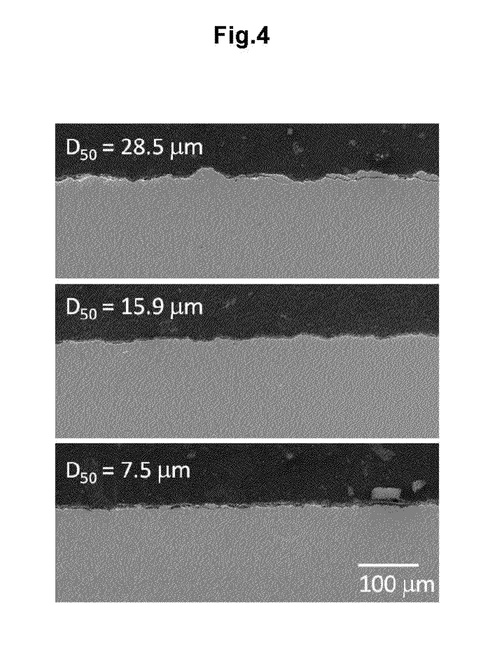

FIG. 4 represents cross section structures near the surface of the cermet coatings produced by using the WS technique from spraying particles of the composition containing 12 mass % Co and of different average particle diameters (D50=28.5 μm, 15.9 μm, 7.5 μm). It was confirmed that the surface became smoother with decreasing average particle diameters of the spraying particles.

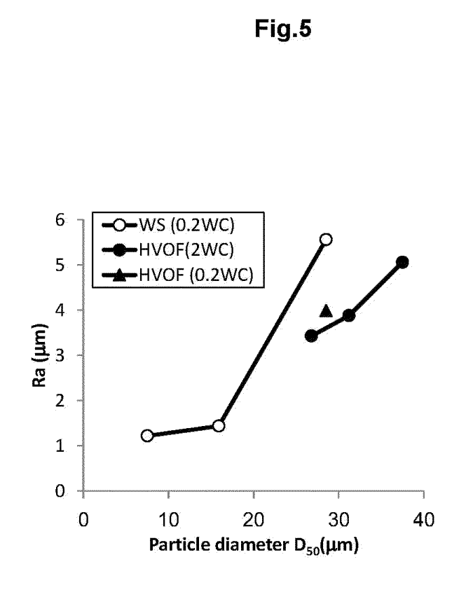

FIG. 5 represents Ra of the cermet coating along the direction parallel to the direction of gun movement plotted against the average particle diameter of each spraying particle. The blank circle represents the cermet coating by the WS technique, the solid circle the cermet coating by the HVOF technique (WC particle diameter: 2 μm), and the solid triangle the cermet coating by the HVOF technique (WC particle diameter: 0.2 μm).

It can be seen that the surface roughness becomes dramatically smaller with decreasing average particle diameters of the spraying particles, both in the WS technique and the HVOF technique. In the cermet coating produced by the WS technique, the roughness was on the order of from 1 to 6 μm, sufficiently larger than the WC particle diameter 0.2 μm of the spraying particles forming the coating.

It can be said from these results that the surface roughness is more strongly influenced by the secondary particle diameter than by the primary particle diameter. This coincides with the result for the cermet coatings produced by the HVOF technique, in which the surface roughness hardly showed any difference between the powders that had the primary particle diameters of 0.2 μm and 2 μm (FIG. 5).

From the trend seen in the figure, it is expected that the cermet coating produced by the HVOF technique also can be obtained as a smooth coating with the use of spraying particles having a smaller average particle diameter. However, with the HVOF technique, it is highly probable that spitting occurs and deposition fails as in experiment number HVOF3 of Example 1 when the average particle diameter of the spraying particles is too small.

On the other hand, with the WS technique, the flame temperature can be controlled, and the spraying particles can adhere without being melted. The WS technique can thus deposit even spraying particles with D50<20 μm without causing spitting, and provide a very smooth coating with Ra<1.5 μm.

By comparing the Ra values of the cermet coatings produced by the WS technique and the HVOF technique using spraying particles of substantially the same size (D50=26 to 29 μm), the flatness improved in the cermet coating produced by the HVOF technique, which involves melting of the spraying particles and is more suited for flattening the coating.

### Example 3

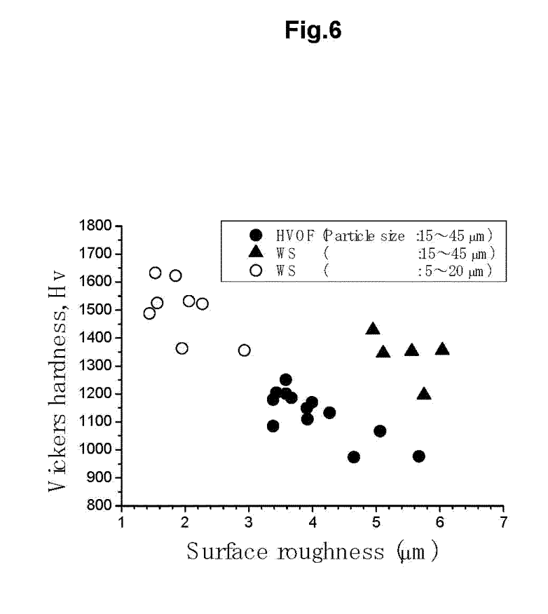

WC-Co coatings (cermet coatings) were produced by using the WS technique or HVOF technique, using WC-12 mass % Co spraying particles including a powder for a hard phase WC and a powder for a binder phase Co, and using a carbon steel (JIS SS400) as the base. Two types of spraying particles with the particle diameter ranges of 5 to 20 μm and 15 to 45 μm were used. These particles are aggregates of the powder for a hard reinforcement phase and the powder for a binder phase, and were obtained in the same manner as in Example 1. FIG. 6 represents surface roughness Ra (center-line average roughness) and the cross section hardness (Vickers hardness, Hv) of the cermet coating.

With the use of the fine spraying particles in the WS technique, it was possible to produce a cermet coating having a hardness of 1,350 to 1,650 Hv. The Vickers hardness of the cermet coating was at least 50% of the inherent Vickers hardness of the powder for a hard reinforcement phase. Further, the cermet coating had an Ra value of 3.0 or less, 2.5 or less, 2.0 or less, or 1.5 or less; that is, the cermet coating had a smoother surface.

### Example 4

WC-Co coatings (cermet coatings) were produced by using the WS technique, using WC-12 mass % Co spraying particles including a powder for a hard phase WC and a powder for a binder phase Co, and using a carbon steel (JIS SS400, dimensions: 100×50×5^{t} mm) as the base. The surface roughness of the cermet coating was measured along the direction parallel to the direction of gun movement (base longitudinal direction, x direction) and in the orthogonal direction (y direction) for every 50 to 60 μm thickness deposited on the base, and surface roughness changes were evaluated. The spraying particles are aggregates of the powder for a hard reinforcement phase and the powder for a binder phase, and were produced in the same manner as in Example 1.

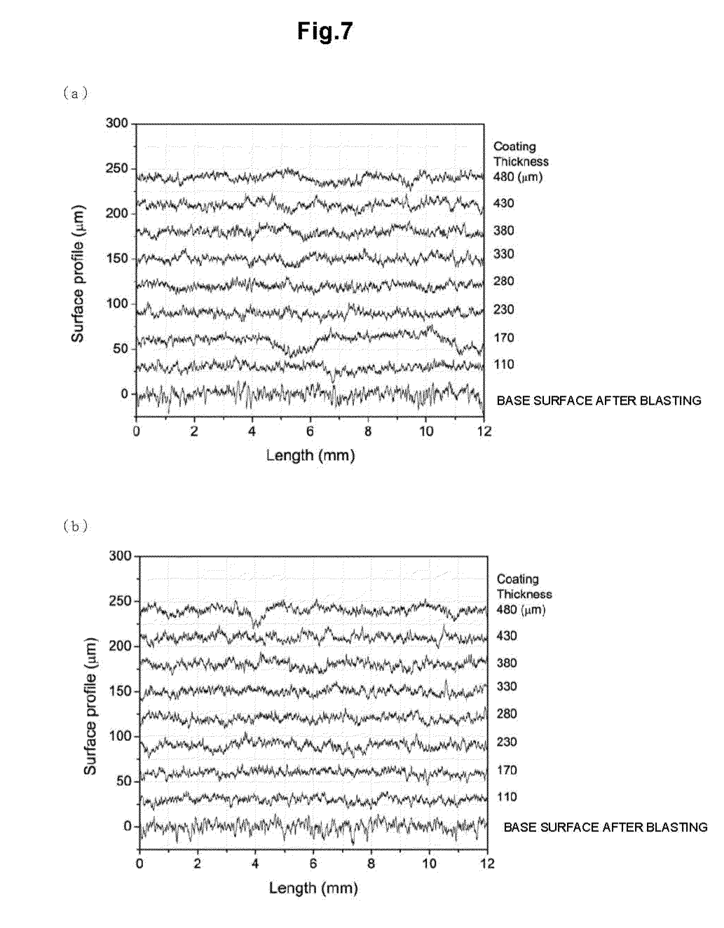

FIG. 7, (a), is the result of the measurement of the cermet coating surface roughness along the x direction, and FIG. 7, (b), is the result of the measurement of the cermet coating surface roughness along the y direction. FIG. 7, (a) and (b), also shows the surface roughness of the base surface after blasting (the base before deposition). In FIG. 7, (a) and (b), the horizontal axis represents the measured distance, the left vertical axis represents the surface profile, and the right vertical axis represents the coating thickness.

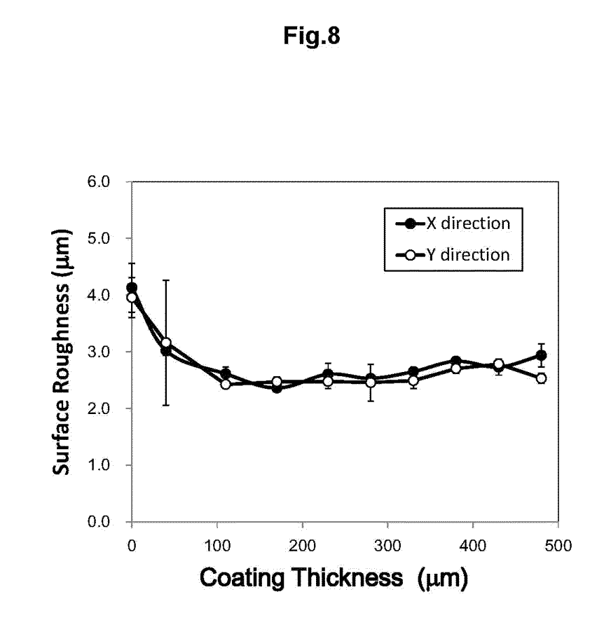

FIG. 8 represents the surface roughness Ra (center-line average roughness) of the base after blasting, and the surface roughness Ra (center-line average roughness) of the cermet coating measured for every 50 to 60 μm thickness deposited on the base. The solid circle represents the surface roughness along the x direction, and the blank circle represents the surface roughness along the y direction.

As can be seen in FIG. 8, a cermet coating with an Ra of 3.0 or less was produced. It was confirmed that the Ra value was the smallest at the cermet coating thickness of about 100 to 200 μm, and gradually increased with increasing thicknesses. It was also confirmed that the cermet coating grown to the final thickness of 100 μm or more after the 50 to 60 μm stepwise deposition had a greater Ra value than the cermet coating of a 100 μm or greater thickness deposited by being continuously sprayed.

### DESCRIPTION OF REFERENCE NUMERALS AND SIGNS

1 Fuel inlet
2 Oxygen gas inlet
3 Spark plug
4, 7 Coolant
5 Inert gas inlet
6 Feedstock supply port
8 Spraying particles
9 Combustion chamber
10 Mixing chamber
11 Supersonic nozzle
12 Barrel
13 Cermet coating
14 Base

1. A cermet coating comprising a hard reinforcement phase and a binder phase formed on a base surface by the collision of spraying particles with a base, the spraying particles including a ceramic powder as a powder for a hard reinforcement phase for forming the hard reinforcement phase of the cermet coating, and a metal powder as a powder for a binder phase for forming the binder phase of the cermet coating,
wherein the cermet coating has a Vickers hardness of from 50% to less than 100% of the Vickers hardness of the powder for a hard reinforcement phase.

2. The cermet coating according to claim 1, wherein the cermet coating has a surface roughness (center-line average roughness Ra) of less than 3.0.

3. The cermet coating according to claim 1, wherein the spraying particles are aggregates of the powder for a hard reinforcement phase and the powder for a binder phase, and the cermet coating is formed by the integration of the powder for a hard reinforcement phase and the powder for a binder phase after the spraying particles are heated and applied onto the base at a supersonic velocity.

4. The cermet coating according to claim 1, wherein the powder for a hard reinforcement phase is one or more carbide ceramics selected from WC, Cr₃C₂, VC, NbC, TaC, TiC, ZrC, HfC, SiC, and B₄C, or one or more non-carbide ceramics selected from diamond, TiN, AlN, HfB₂, ZrB₂, TaB₂, and TiB₂.

5. The cermet coating according to claim 1, wherein the powder for a binder phase is one or more metals selected from Ni, Cr, Co, Ti, Al, and Fe, or an alloy thereof.

6. A spraying particle comprising a powder for a hard reinforcement phase and a powder for a binder phase for forming the cermet coating of claim 1,
wherein the powder for a binder phase accounts for not more than 25 mass % and not less than 8 mass % of the total of the spraying particle.

7. The spraying particle according to claim 6, wherein the powder for a hard reinforcement phase and the powder for a binder phase form an aggregate.

8. A coated article comprising a base that includes the cermet coating of claim 1 formed on a base surface.

9. A method for forming the cermet coating of claim 1, the method comprising:
heating spraying particles that include a ceramic powder for a hard reinforcement phase for forming the hard reinforcement phase of the cermet coating, and a metal powder for a binder phase for forming the binder phase of the cermet coating; and
causing the spraying particles to collide with the base at a supersonic velocity to deposit the cermet coating having a hard reinforcement phase and a binder phase.

10. The cermet coating forming method according to claim 9, wherein the spraying particles collide with the base after being heated to not less than the softening temperature and less than the melting temperature of the metallic component forming the powder for a binder phase.

11. The cermet coating forming method according to claim 9, wherein the spraying particles are aggregates of the powder for a hard reinforcement phase and the powder for a binder phase.
